(19) United States
(12) Patent Application Publication
(10) Pub. No.: US 2011/0186619 A1
(43) Pub. Date: Aug. 4, 2011

(54) Envelope with integrated removable components

(76) Inventor: John Moresi, St. Louis, MO (US)

(21) Appl. No.: 12/930,976

(22) Filed: Jan. 21, 2011

Related U.S. Application Data
(60) Provisional application No. 61/337,044, filed on Jan. 30, 2010.

(51) Int. Cl. B65D 27/04; B31B 1/90; B31B 1/62; B31B 1/14; B31B 1/88

(52) U.S. Cl. 229/71; 493/214; 493/243; 493/264; 493/227; 493/187

(57) ABSTRACT

An envelope for direct mail marketing with an integrated component that may be peeled out to reveal a transparent polyester-like splittable laminate, allowing the recipient to view the contents of the envelope. The removed component may serve as a coupon, label, tag, or other useful component. The removable component may also be affixed to the inner surface of the envelope to be viewable by the recipient.

### CROSS REFERENCE TO RELATED APPLICATION

This non provisional patent application claims priority to the provisional patent application having Ser. No. 61/337,044, having filing date Jan. 30, 2010.

### BACKGROUND OF THE INVENTION

This invention relates to a direct mail marketing envelope with a removable component or components integrated into the envelope. Direct mail envelopes have been used for many years as a tool to carry information and to excite a response from the recipient. Envelopes have been modified in various ways in an effort to improve the rate of desired response. The modification of the present invention adds to the utility of a direct mail envelope and provides a means of raising the recipient's sense of intrigue.

U.S. Pat. No. 7,213,844 to Malette, et al., discloses an envelope with integrated tracking labels. The Malette envelope has a removable tracking label, used to confirm receipt of the envelope, integrated in the sealing flap of the envelope.

Examples of prior art showing the use of integrated components in business forms include, for example, U.S. Pat. Nos. 5,782,497; 6,022,051; and 6,352,287; all to Casagrande, which disclose detachable cards integrated into business forms. Another U.S. Pat. No. 5,807,623 to Chess, discloses an integral label with carbonless coating. It is clear that the use of integrated cards and labels in business forms is well established.

The present invention uses the idea of integrated components in an envelope especially designed for direct mail. In this invention, the components included directly in the envelope serve to entice the recipient and to elicit a desired response from the recipient. The envelope improves upon the prior art by efficiently adding a new degree of utility to a direct mail envelope while at the same time expanding the envelope's ability to serve as a marketing vehicle.

### SUMMARY OF THE INVENTION

The present invention, however, uses components directly integrated in an improved envelope for direct mail marketing. In the preferred embodiment, the envelope of the present invention has one or more integrated sections which can be removed by peeling along a die cut in the face of the envelope. The peeled-out section becomes a coupon, label, tag, or other useful component. In addition, removal of the integrated section from the envelope reveals a window of transparent polyester-like splittable laminate through which the contents of the envelope may be viewed. Thus, rather than using an insert with a coupon, label, or other useful component, the sender may integrate the useful component into the envelope itself. Removal of the integrated envelope component further reveals useful or enticing contents inside the envelope to excite the desired response from the recipient.

The integrated nature of the envelope components facilitates printing the entire envelope blank at once, rather than having to print separate components and attach them to the envelope or include them in the contents of the envelope. Embodiments of the envelope may be varied in a number of ways to meet the needs of the user.

In another embodiment, the envelope may have one or more die cut windows in the front and/or rear panel, each with a layer of transparent splittable laminate glued to the inner face of the envelope to cover the window opening created by removal of the die cut area. An insert may be joined by a weak adhesive to the inner surface of the transparent laminate so that a graphic display on the face of the insert may be viewed by the envelope recipient, enticing the recipient to open the envelope. Upon opening the envelope, the recipient may peel the insert away from the transparent laminate, so that the insert may be used as a functional component. The insert itself may have integrated components, such as stickers, decals, or other peelable units, which may be used by the recipient in a manner desired by the sender.

### BRIEF DESCRIPTION OF THE DRAWINGS

For the purpose of illustration, this description includes references to the accompanying drawings. It is understood, however, that the invention is not limited to the preferred embodiment illustrated in the drawings.

FIG. 1A is a front view of an envelope with a card or label integrated into the front section of the envelope;

FIG. 1B is a rear view of the same envelope with a card or label integrated into the rear panel of the envelope;

FIG. 2 is a perspective view of the outside surface of the unfolded envelope blank. The front panel of the envelope is shown with an integrated card or label partially removed from the envelope to reveal the transparent splittable laminate beneath; and

FIG. 3 is a perspective view of the inside surface of the unfolded envelope blank. The transparent laminate can be seen glued to the inner surface of the front panel.

### DETAILED DESCRIPTION OF THE INVENTION

With reference to the drawings:

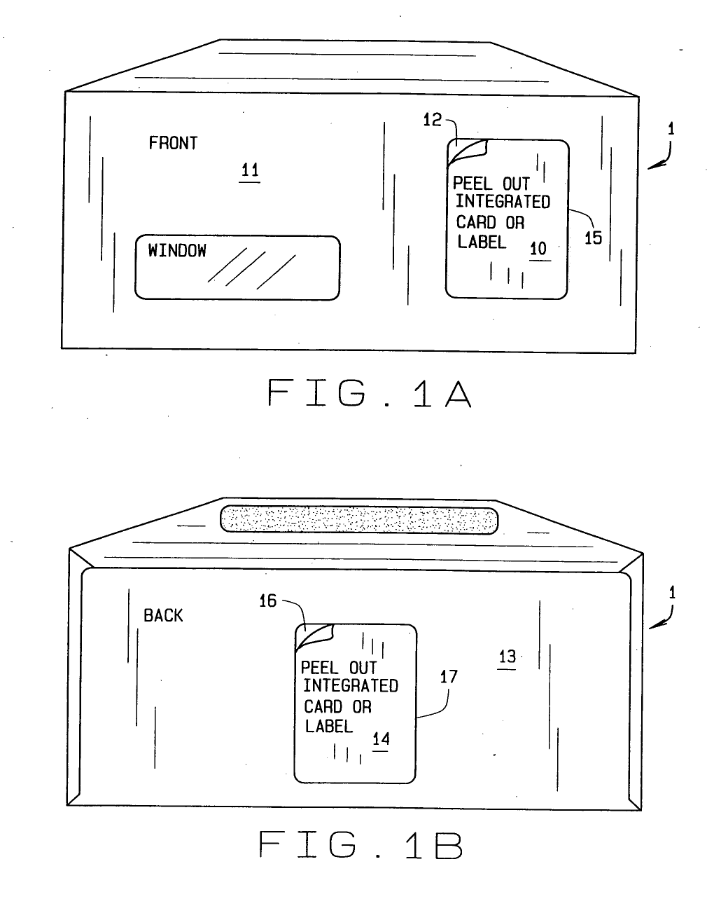

FIG. 1A shows a front view of envelope 1. Card 10, integrated into front panel 11, is shown partially peeled along die cut 15 to reveal transparent polyester-like splittable laminate 12 below. The panel of splittable laminate 12 is glued to the inner face of front panel 11.

FIG. 1B shows a rear view of the folded envelope 1. Card 14, integrated into rear panel 13, is shown partially peeled along die cut 17 to reveal transparent polyester-like splittable laminate 16 below. The panel of splittable laminate 16 is glued to the inner face of rear panel 13.

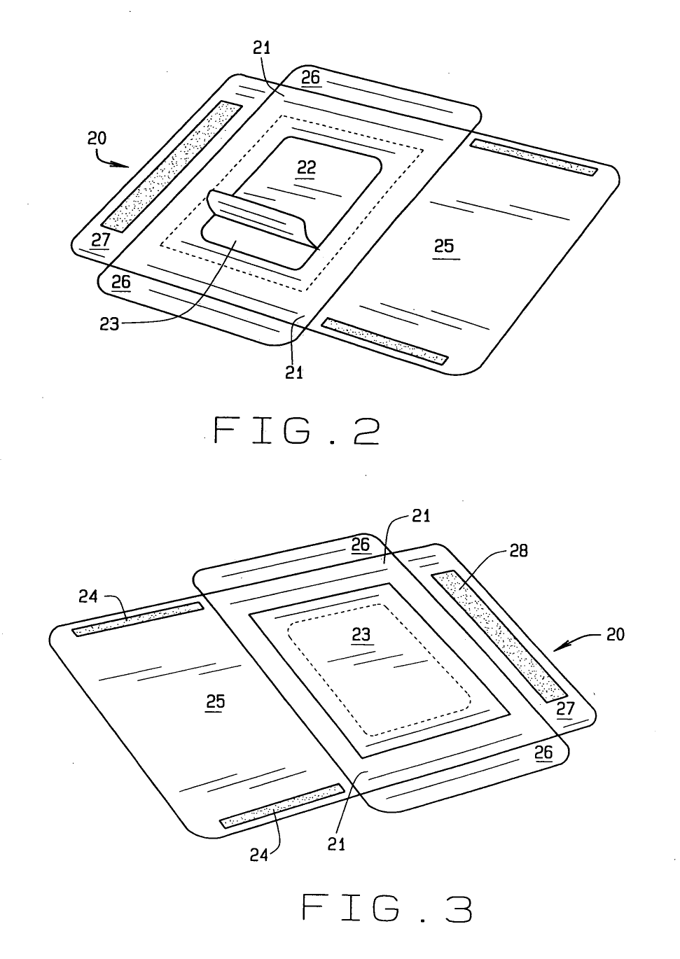

FIG. 2 is a perspective view of the outer surface of unfolded envelope blank 20. Card 22, integrated into front panel 21, is shown partially peeled out to reveal transparent polyester-like splittable laminate 23, which has been bonded to the opposite face of panel 21. The broken lines in the drawing represent the locations of the adhesives, gum, and transparent laminate, labeled 24, 28, and 23 respectively in FIG. 3, which would be visible on the other side of envelope blank 20.

FIG. 3 is a perspective view of the inner surface of unfolded envelope blank 20. The blank is cut so that the envelope may be constructed by folding tabs 26 inward and folding rear panel 25 upward so that the adhesive 24 joins rear panel 25 with tabs 26. As may be seen and comprehended, the envelope is sealed by folding sealing flap 27 over-rear panel 25 so that bonding agent 28, which may be a gum Arabic, dextran-based gum, or another gum, may join sealing flap 27 to panel 25. Transparent polyester-like splittable laminate 23 is shown bonded to the inner surface of front panel 21. The broken lines in the drawing represent the die cut in the opposite face of panel 21.

What is claimed is:

1. An envelope comprising a blank of paper or synthetic material;
said blank being die cut to include a) a front panel; b) a rear panel, integrally formed with and separated by a fold line from said front panel; c) side tabs, integrally formed with and separated by a fold line from said front panel; and d) a sealing flap, integrally formed with and separated by a fold line from said front panel, such that said blank may be folded into a typical envelope with front and rear panels and a flap for sealing the envelope closed;
one or more panels of transparent splittable polyester-like laminate bonded to the inner face of said front layer; and
one or more die cut areas through the planar surface of said front panel, so as to allow for easy tearing along the die cut or cuts to expose said transparent splittable laminate.

2. The envelope of claim 1, wherein the rear panel includes a panel or panels of transparent polyester-like splittable laminate bonded to the inner face of said rear panel and one or more die cut areas through the planar surface of said rear panel, so as to allow for easy tearing along the die cut or cuts to expose said transparent splittable laminate.

3. The envelope of claim 1, wherein a portion of the outer surface of the envelope is removed to expose said panel or panels of transparent splittable laminate, and an insert is joined by a weak adhesive to the inner face of the envelope so that a graphic display on the insert is visible from the outside of the envelope through the panel of transparent splittable laminate and the insert may be easily removed from the inner face of the envelope.

4. The envelope of claim 3, wherein said insert includes integrated components which may be removed and used by the recipient of the envelope.

5. A method of making the envelope of claim 1, comprising the steps of
a) die cutting paper or synthetic stock material into a blank with two faces; hereinafter called the inner face and the outer face, said blank consisting of a rear panel; a front panel integrally formed with said rear panel and separated by a fold line; side tabs integrally formed with said front panel and separated from said front panel by fold lines; and a sealing flap integrally formed with said front panel and separated from said front panel by a fold line;
b) applying an adhesive along the lateral extremes of said inner face of said rear panel, such that said adhesive will align with and bond to said side tabs when the envelope is folded;
c) applying along said inner face of the sealing flap a moisture-activated gum arabic or dextran adhesive of the type commonly used in the industry for envelope sealing flaps, such that said sealing flap may when folded be joined with said rear panel to secure the envelope;
d) affixing to said inner face of said blank one or more panels of transparent polyester-like splittable laminate of a type commonly used in the manufacture of window envelopes; and
e) making at least one die cut through said outer face of said blank to said panel or panels of transparent splittable laminate, such that said blank may be easily torn along said die cut to separate a portion or portions of said blank from said transparent splittable laminate.

6. The method of claim 5, wherein the blank is printed on one or both sides prior to attaching the transparent polyester-like splittable laminate.

7. The method of claim 5, wherein said side tabs are integrally formed with said rear panel and adhesive is applied along the lateral extremes of said inner face of said front panel, such that said adhesive will align with and bond to said side tabs when the envelope is folded.

8. The method of claim 5, wherein said die-cut area or areas of the face of said envelope are removed to reveal said panel or panels of transparent splittable laminate, and at least one insert is affixed by a weak adhesive to the inner face of said envelope so as to be visible through said panel or panels of transparent splittable laminate.

9. The method of claim 8, wherein at least one of said inserts is die cut to include one or more integrated components that may be easily peeled out of the insert along the borders of the die cut.
